(19) United States
(12) Patent Application Publication
(10) Pub. No.: US 2002/0138399 A1
(43) Pub. Date: Sep. 26, 2002

(54) Method and system for creating and using a peer-to-peer trading network

(76) Inventors: Philip J. Hayes, Pittsburgh, PA (US); Aidan J. McKenna, Sewickley, PA (US); Bruce M. McLaren, Pittsburgh, PA (US)

Correspondence Address: MORGAN LEWIS & BOCKIUS LLP, 1111 PENNSYLVANIA AVENUE NW, WASHINGTON, DC, 20004, US

(21) Appl. No.: 09/890,892

(22) PCT Filed: Feb. 23, 2001
(86) PCT No.: PCT/US01/05609

(51) Int. Cl. G06F 17/60

(52) U.S. Cl. 705/37

(57) ABSTRACT

The method and system of the present invention provide an electronic platform that enables any participant in a trading network to trade with any other participant in the trading network according to its own individual trading rules. The trading rules are individual and private, and each participant may have a plurality of rules that govern trading. The trading rules may include Buy-side trading rules that govern partner selection and offer to sell evaluation, and Sell-side trading rules that govern how a participant responds to a request. The trading rules may be applied by the system in a manner that automates the purchasing process, or may be used to rank a participant's choices according to the participant's preferences. The trading network is preferably integrated the participants' internal systems.

### FIELD OF THE INVENTION

The present invention generally relates to a computer-based method and system for trading goods and services. In particular, the system and method of the present invention provides an electronic platform that enables any participant in a trading network to trade with any other participant in the trading network according to its own individual trading rules.

### BACKGROUND OF THE INVENTION

Historic Perspective

Computerized trading is not a new phenomenon. Ever since the arrival of computers that could communicate across phone lines, starting around the mid 1960's, electronic forms of trading have been widely deployed.

Beginnings of the Exchange Model

Early developments included computerized airline reservations systems, followed by banking and later general users. Around 1970, a new type of electronic trading emerged, where no one party was the “host” of the system. These were the systems that permit the trading of securities between brokers located at their respective offices rather than on a stock exchange “floor”. This is the “Exchange Model” of trading, and it has revolutionized the way securities and financial commodities are traded. The Exchange Model has been a resounding success, and is often credited with making possible the global securities trading systems we have today.

EDI and Value Added Networks

Around 1980, industrial companies came together under the auspices of the IT community's standards body, ANSI (American National Standards Institute) and defined another new form of electronic trading, called Electronic Data Interchange (EDI). The purpose of EDI was to break down certain technical barriers that made it difficult for manufacturers and their partners to perform the type of electronic trading that was becoming routine in the securities and financial services sector. Trading manufactured goods and services is considerably more complicated than trading securities. The most significant reasons for this are:

1. Manufactured goods are not undifferentiated commodities in the manner that one IBM share is a clone of any other. There are questions of quality, delivery promises and other differentiators.

2. The essence of a securities transaction is to get the very best deal for the buyer or seller every time a transaction takes place, while in the world of manufactured goods, it is normal for the relationship between two trading partners (say Michelin and Ford Motor) to be more important than the exact details of a particular transaction.

3. Securities transactions are heavily regulated and the rules of engagement are legally circumscribed. Thus, it is possible to have a central exchange which acts not just as a traffic cop but also a surveillance cop to ensure that all traders, big or small are treated in the same manner and have an equal opportunity to have their trade filled. In most industries, however, the norm is that enterprises wish to treat different trading partners in different ways.

EDI was developed to address these needs. EDI has two components, a standard format for different types of transactions, such as invoices, orders etc, so that all parties have a lingua franca to do business, and a Value Added Network (VAN). A VAN is a type of exchange that operates like a Post Office Box (PO Box) service. Traders send standard messages to a central “exchange” usually operated as an independent business, and the exchange “holds” the messages in numbered “mailboxes” until they are picked up by the addressees when they electronically “call in”. EDI has been very successful as a means of transacting business between large businesses, but it has largely failed to attract any but the larger entities.

Electronic Commerce over the Internet

The wide availability of the Internet and the World Wide Web has given another impetus to the drive for universal electronic trading. Computer-using consumers are familiar with the many thousands of websites that permit shopping for and ordering of goods and services, and auction sites for the purchase and sale of just about anything. These types of sites are commonly referred to as “Business to Consumer” (B2C) sites because transactions mainly take place between retailers (sometimes called “eRetailers” or “etailers”) and end users. A merchant is typically the “host” of the system and consumers access the site through browser software installed on their personal computers.

There are also a great many “Business to Business” (B2B) sites, where businesses may access a host's website and initiate transactions similar to B2C. Examples include Cisco's renowned website through which businesses order billions of dollars worth of communications equipment every year. B2B electronic trading (often called “eBusiness” or “eCommerce”) is widely deployed and successful.

The Internet is a compelling electronic commerce platform for many reasons. Access to the Internet is ubiquitous. Even the simplest networked computer capable of running a browser provides a real-time window to the entire Internet. The transaction process—deciding what to buy/sell, actually buying or selling, and the trade settlement—can be done in a very efficient manner using the Internet. Information on the Internet is easily updated, and is instantaneously available to all interested parties. Buyers and sellers can share important information about each aspect of the transaction decision. As participation in electronic markets increases, so too do choices and opportunities to consummate transactions in a manner that more efficiently meets the needs of buyers, sellers, and market makers. The more consumers and businesses that are connected to the Internet, the greater its value: the so-called “network effect”.

Early E-commerce on the Internet

When business first moved to the Internet, and the term e-commerce was coined, companies simply replicated traditional business practices on the Internet. For instance, many of the existing online markets use a “catalog” model of commerce, which basically makes hardcopy catalogs available to buyers electronically via the Internet. These first electronic catalogs allowed buyers to obtain information about which products were offered (but not their in-stock status), and to order products online. This model is able to take advantage of the Internet's global reach and around-the-clock availability to deliver customer convenience, but the actual business model remains rooted in existing practice.

Offering products online in a static catalog format is, nevertheless, a substantial improvement over older means such as telephones, faxes etc. It is a comfortable way for early electronic market participants to leverage some of the benefits of Internet commerce. Sellers can post price lists, catalogs, and sales brochures already in use. Buyers can peruse information from anywhere and make a purchase at any time.

However, many catalog markets are single-source; i.e., they only allow customers to obtain information and products from one seller. Some electronic catalogs have been updated to include information about competing products; however, many of these systems are biased towards the seller offering the electronic catalog or market.

In addition, the static prices and lack of availability information of catalog markets are a disadvantage. Market conditions are constantly changing, and access to the Internet can provide virtually instantaneous knowledge about market demand. Static catalog markets do not take advantage of real-time market or supply information. Therefore, more dynamic models of e-commerce, such as online auctions and exchanges, were introduced. Through online auctions and exchanges, buyers and sellers are given the ability to buy and sell goods and services over the Internet in an environment where price and availability change with supply and demand.

Auctions on the Internet

Auctions by their nature do not provide symmetry between participants in e-commerce transactions. Most buyer-bidding auctions have one seller, and most reverse auctions have one buyer. Buyer-bidding auctions are designed to benefit the seller by obtaining the highest possible price of a product. Likewise, reverse auctions are buyer-centric, and are designed to benefit the buyer by obtaining the lowest possible price. Reverse auctions, powered by the software and service offerings of industry leaders such as Commerce One, ARIBA, and FreeMarkets, are by far the most common form of B2B auction and represent almost all the dollar volume of auction business. This is generally because manufacturers are unwilling to offer their finished goods, particularly quality branded offerings, on an open auction site. On such sites, price becomes the lowest common denominator and the manufacturers are unable to earn any premium for brand, quality, superior service or the many other important attributes that separate the leading enterprises from their low cost imitators.

The Exchange Model on the Internet

The Exchange Model, based on a central facility into which all transactions are funneled and executed, has been widely implemented as a way to do e-commerce over the Internet in the form of electronic exchanges (sometimes called “eMarketplaces”) for many industries. Electronic exchanges have been created for a wide array of industries. Hundreds of millions of dollars have been invested in these businesses, (often called “Dotcoms”) that designed Websites to act for an industry (like Metals) or series of industries (like Automotive) in a manner similar to the service provided by the original exchanges, the securities businesses. Unlike the other models described in this section, these Dotcoms or eMarketplaces have failed to attract the traffic that they had been expecting and many of the businesses are failing.

Problems with the Exchange Model on the Internet

An electronic B2B exchange allows multiple buyers and multiple sellers to simultaneously conduct trading within a single marketplace. An electronic exchange is therefore less buyer-centric or seller-centric than an online auction, although many electronic exchanges are run by interested parties instead of disinterested third-party market makers. For example, the large automakers, GM, Ford, and Daimler/Chrysler, have created a marketplace called Covisnt for buying from their suppliers.

Participants in the simplest and most common kind of B2B exchange interact with the exchange site directly via an Internet browser. The exchange site is responsible for matching buyers' bids and sellers' offerings, according to criteria set by the exchange. Thus, exchanges are centralized and controlled by a single organization and a fixed set of rules of engagement. Moreover, in many cases, the organization running the exchange is not neutral to the outcome of the exchange's transactions, raising questions of fairness and confidentiality.

Browser access often makes it difficult for companies participating in an exchange to transfer information between the exchange and their internal systems. Frequently, the information has to be rekeyed, either in the exchange browser interface, or in the company's internal system. Because trading is not fully integrated in the participant's business, transactions are much less efficient and cost-effective, and errors are more likely to occur.

Current exchanges operate to match a buyer and seller based upon the parameters of a particular transaction and treats all traders in the same fashion. For a regulated exchange such as a securities exchange, this is not only desirable: it is mandatory. All buyers and sellers have the same status vis-a-vis the exchange and all others. Every item traded (say a share of IBM stock) is considered a commodity and is exactly the same as any other such item (another share of IBM). Consider the difference between this type of exchange and a market for fresh fish, where the actual individual item (one Cape Cod clam, for example) might be very different from another individual with the same description (one Cape Cod clam).

Leaving aside the exchanges dealing with regulated commodities such as securities and basic raw materials, it is not typical to find industrial trading practices that operate to this commodity-type model. More typically, manufacturers, intermediaries and users develop relationships in the form of formal contracts for, say, the purchase and sale of items at agreed terms for an agreed period of time. Even where no formal arrangement exists, it is normal that enterprises have customers and suppliers with whom they have established continuing relationships. Thus, an industrial enterprise is likely to have opinions and preferences for partners and products, and commitments that limit the range of its search when seeking to buy or sell. Even between its established cadre of partners, an enterprise is likely to have preferences, perhaps varying depending on particular circumstances such as time of year, balance of account, volume of business done and others.

Furthermore, an enterprise will typically wish to keep its preferences confidential, and even to its most favored trading partners or the convener of an exchange. In short, modem traders want to differentiate between partners, products, promises and services and to do so based upon the options available at the moment of choice. They want to hold these preferences in complete privacy, and to be empowered to change them under a veil of privacy at any time.

Some of the business requirements not met by most current exchanges have been addressed to some extent within the exchange model. Some exchanges provide ways for partners to submit or receive orders electronically from or to their ERP systems, although the exchanges are not integrated with the ERP systems. Many exchanges have strong confidentiality policies. A few exchanges attempt to provide ways for participants to differentiate their response according to participant. Nevertheless, the exchange model does not provide a means to address all these issues in a manner that is attractive to potential participants. This is one of the major causes of the collapse of so many of these Dotcom entities. Despite investments, sometimes running into hundreds of millions of dollars, exchanges have clearly failed to attract anything but the most anaemic levels of traffic. What has been working for securities exchanges for thirty years was assumed to be the model for other goods and services. The failure of most B2B exchanges shows the folly of that assumption.

Requirements for B2B Electronic Trading

The traditional exchange model, so successful in the securities industry, is the wrong architecture to address today's needs for electronic trading. It is a classic case of a technology looking for a problem. The needs that must be addressed are as follows:

1. Companies need a means of conducting trade with business partners in a manner that is completely automatic and immediate. The connections between independent partners need to be as smooth as they are between different branches of the same company, so that, for example, if something is not available at one location it can be automatically and seamlessly found at another.

2. All aspects of each trading partners business systems need to participate in this smoothness of connectivity, so that there is never a need to manually rekey data from one system to another.

3. This smooth connectivity needs to be deployed while still maintaining the individual autonomy, independence and confidentiality of each participant's internal records such as inventory levels, differential pricing, different preferences between trading partners and more.

In view of the foregoing, it can be appreciated that a substantial need exists for a trading network that provides computer-to-computer connectivity, peer-to-peer trading, and the ability to apply intelligent business rules in the trading network. The idea is that the hundreds, or even thousands of participants in a channel can feel connected to the inventory of every other participant, while at the same time no participant feels exposed to the prying eyes of competitors, and all can react immediately to opportunities.

### SUMMARY OF THE INVENTION

The trading network of the present invention improves buyer and seller satisfaction: buyers can choose an option from a range of alternatives based upon a number of preferences they may have including but not limited to, seller, brand and the best price; sellers can choose to offer an option based upon their preferences which can include a series of criteria including but not limited to, buyer, optimal inventory levels and the best margins. The trading network of the present invention uses computer-to-computer connectivity for real-time execution of orders. It allows for peer-to-peer trading, and lets participants establish individual trading rules. It allows a participating buyer to respond to offerings made anywhere on the network, and assists the buyer in examining potential product offerings and evaluating terms offered, all automatically, tempered to the exact preferences of this buyer at this time.

The method and system of the present invention puts e-commerce inside core business systems. A participant in the trading network of the present invention can search for inventory among other trading partners—from the same system that it searches its own inventory. Using the inventive system, a participant no longer must exit its POS application, or log on to a browser-based website to find the information or products it needs. As a result, there is no need to keep switching backwards and forwards between different systems such as POS, Inventory, Browsing, and Trading. The whole job is handled, in the background by the computer from a single entry of the operator. Computer-to-computer connectivity also means that participants are connected to real-time inventory information, thereby ensuring that the information is up-todate. This allows a seller's promise of delivery to be accurate and reliable and allows buyers to confidently make promises to their customers based on the inherent reliability of the connected network. It is similar to the confidence travel agents place in a networked airline reservation system; they are empowered to enter into firm sales agreements for inventory (seats) that are not under their ownership or control.

The trading network of the present invention enables retailers, distributors and manufacturers to trade with each other on a peer-to-peer basis. That means that each participant, small and large, powerful and weak, has the same access and visibility to every other participant. Distributors can buy from or sell to other distributors. Anyone on the network can trade directly with anyone else. This type of peer-to-peer trading allows ecommerce conducted using the inventive system to enjoy the full benefit of the network effect.

In the trading network of the present invention, buyers and sellers retain control and freedom to make their own strategic and operating decisions regarding the way they interact with other participants. They are also able to keep their rules and strategies secret from other network participants. Participants are not forced to succumb to an exchange's or a manufacturer's decision rules. Each participant establishes its own trading rules, (e.g. “I will never sell to/buy from X”, “I'll sell to Y, but at a 20% markup”, “I'll sell to Z at a 3% markup”). These individual trading rules protect autonomy and privacy.

One benefit of the trading network of the present invention is that businesses can compete on non-price variables, such as brand, product, service, functionality, delivery, and most importantly, relationship or contractual obligation.

Another benefit of the trading network of the present invention is that each participant's fulfillment capability is expanded because the power of the entire channel is leveraged. Businesses can fulfill more orders without increasing inventory levels.

Yet another benefit of the trading network of the present invention is that network participants maintain control over internal information.

One embodiment of the invention comprises a method of fulfilling a request on a trading network comprised of a plurality of trading partners, comprising the steps of sending a request to at least one trading partner, whereby the request is sent only to trading partners chosen by a trading rule; receiving at least one response to the request from the at least one trading partner; ranking the at least one responses according to an evaluation rule; and accepting one of the at least one responses.

Another embodiment of the invention comprises a method for a node in a trading network to respond to a request for a specified quantity of specified goods, comprising the steps of: receiving a request; determining whether to respond to the request according to a trading rule; generating a response according to said determination, wherein said response includes at least one node preference; and responding to the request with the generated response.

Yet another embodiment of the present invention comprises a method for a requesting node to determine which of a plurality of offers to accept, comprising the steps of receiving a plurality of offers; ranking said offers using an evaluation rule; and determining whether to accept an offer.

Yet another embodiment of the present invention provides for a trading network that composed a plurality of nodes, wherein at least one node is a different type of entity than at least one other node; wherein any node participating in the trading network can trade with any other node in the trading network; wherein each node has a set of private, individual trading rules that govern that node's trading behavior; and wherein a first node may send a trading request to at least one second node according to the first node's trading rules, and the at least one second node determines whether to respond to the trading request according to each of the at least one second node's trading rules.

Yet another embodiment of the present invention provides a method for a node in a trading network to make a request to at least one other node on the trading network, comprising the steps of: calculating a score for each of a plurality of trading nodes on the trading network using at least one rule established by the requesting node; for each of the plurality of trading nodes, determining if the calculated score meets a minimum threshold; and sending a request from a requesting node to any trading nodes that have a minimum score; wherein the trading network makes the determination and automatically sends the requests to the trading nodes with a minimum score.

With these and other advantages and features of the invention that will become hereinafter apparent, the nature of the invention may be more clearly understood by reference to the following detailed description of the invention, to the appended claims and to the several drawings attached herein.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates one embodiment of the trading network of the present invention;

FIG. 2 is a block diagram illustrating the components of a central repository used in the trading network of the present invention;

FIG. 3 is a block diagram illustrating an architecture for one embodiment of a node in the trading network of the present invention;

FIGS. 4A-4D are block diagrams illustrating some of the internode messaging used by the trading network of the present invention to process a transaction;

FIG. 5 is a screen display illustrating an example of offers to sell ranked by the trading network of the present invention;

FIGS. 6A-6C are block flow diagrams illustrating an example of a purchase request transaction using the trading rules of the trading network of the present invention;

FIGS. 7A-C are block flow diagrams illustrating an example of a purchase request transaction using the trading rules of the trading network of the present invention;

FIGS. 8A-B are block flow diagrams illustrating an example of a purchase request transaction using the trading rules of the trading network of the present invention;

FIGS. 9A-B illustrate examples of some of the types of messages used by the trading network of the present invention; and

FIG. 10 is a block flow diagram illustrating an example of a transaction that uses internode and intranode messaging by the trading network of the present invention to process the transaction.

### DETAILED DESCRIPTION

Reference will now be made in detail to the embodiments of the invention, examples of which are illustrated in the accompanying drawings. Wherever possible, the same reference numbers will be used throughout the drawings to refer to the same or like components.

It is worthy to note that any reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

The embodiments of the invention provide for a trading network that permits commercial activity to be conducted electronically between autonomous independent businesses that electronically collaborate with one another to provide goods and services to their customers. Members of this network may be manufacturers, distributors and retailers, for example. In a preferred embodiment, the network is comprised of a variety of types of businesses, and is not dominated by any one type of organization.

In traditional exchange-based trading, a central node typically controls distribution and market making. In this type of trading, a participant is required to expose information to others through the central node. However, in the trading network of the present invention, no one single member controls other members or the network, and each participant controls its own internal information. Preferably, no member has any knowledge of any other member's preferences, rules or criteria. The member can observe another member's response or request but cannot infer from them anything about the other member's rules of engagement. This is an important point of differentiation between the present invention and the exchange model used by most Dotcoms.

Decisions in the trading network of the present invention—such as choosing potential buyers or suppliers, responding to offers to buy or sell, prioritizing options—are generally governed by each participant's personal and private trading rules. With these rules, potential sellers may customize pricing based on the potential buyer, for example. The trading rules ensure a personalized sourcing solution; the inventive system enables participants to buy from and sell to others electronically in whatever sequence, with whatever priority and on whatever terms they decide.

Participants in the trading network of the present invention preferably have the ability to both buy and sell, although they may choose to deploy rules that effectively make them a buyer-only or a seller-only. Typically, a participant initiates a purchase using the inventive system by sending a purchase request to other participants in the network. These recipient participants may then respond to the purchase request with offers to sell. In an alternative embodiment, a participant may initiate a sale using the inventive system by sending a sale request to other participants. Participants may respond with offers to buy.

The trading network of the present invention referably supports both purchase requests and sale requests, although individual participants may choose to use only one. In addition, the trading network may support other types of requests and transactions, such as unsolicited offers to sell, inventory inquiries, invoicing (for orders placed outside the trading network, for example), advanced shipping notices and firm orders, for example. As will be obvious to one skilled in the art, there are many different types of transactions that may be supported by the trading network of the present invention.

System Architecture

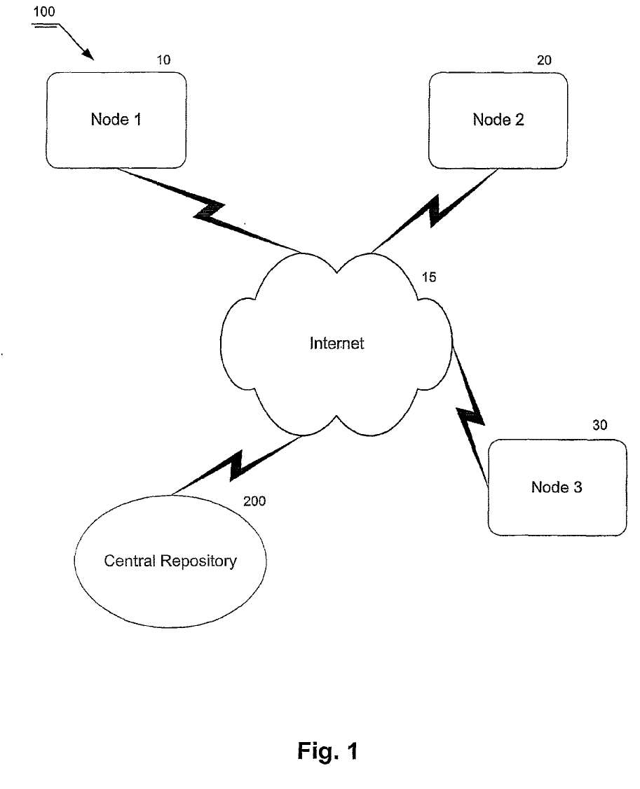

One embodiment of the trading network of the present invention is shown in FIG. 1. As shown, trading network 100 is essentially a collection of nodes 10, 20, 30, etc. each node representing an independent business entity. A node may be a retailer, a distributor, or a manufacturer, for example. The nodes are preferably connected with each other over the Internet 15, although any type of computer network, such as a private Intranet, may be used. In the case of an Internet connection the participants, in effect, are all connected to each other on a one-to-one basis, although the only physical connection required for any individual participant is a single connection to the Internet itself. The Internet is a peer-to-peer network and it automatically “finds” appropriate choices for a participant based upon the information stored by the Intelligent Trading Module.

The embodiment shown in FIG. 1 illustrates a central repository connected to the trading network. Central repository 200 does not typically participate directly in trading activities, rather, it supports network activities and maintains information about each of the nodes. Trading activities are conducted on a peer-to-peer basis between the nodes in the network, and nodes obtain information from the central repository when needed. Thus, business transacted between two partners is not known to any node (or the central repository) except the two individual partners themselves.

In an alternative embodiment, the trading network does not include a central repository. In this case, information external to each node can be distributed to the nodes using other methods, such as on a CD. Other architectures and storage and distribution methods will be obvious to those skilled in the art and are intended to come within the scope of the present invention.

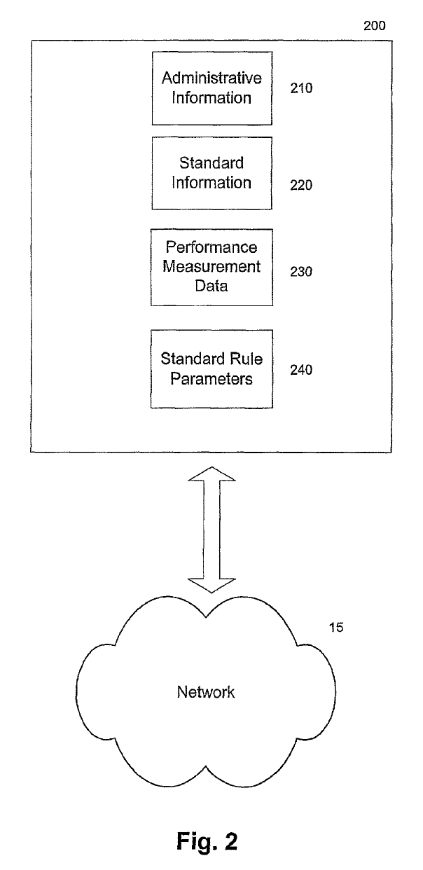

FIG. 2 illustrates one embodiment of an architecture for a central repository used by the inventive system. Central repository 200 may be used to maintain a variety of information. It typically stores administrative information 210, such as communication and contact information for each of the trading nodes in the network. Since communication within the inventive trading network is typically via the Internet, contact information may include Internet Uniform Resource Locators (URLs). The central repository may also store a centralized listing of standard or industry information 220 that is used by the nodes when trading. For example, it may store standard manufacturer part numbers. This type of information may be used for validation of part numbers used in requests or offers from trading partners, for example, or for allowing dealers to determine potential substitutions for items they do not carry.

The Central repository may also provide a place to accumulate measurable performance data 230. For example, the Central repository may collect information on delivery performance by nodes. The Central Repository could then provide performance data back to participants, as a value-added service. For example, if the Central Repository accumulated and stored delivery performance data, a network participant that required exceptional delivery from its suppliers could then obtain up-to-date, accurate information regarding how well potential suppliers have met delivery deadlines in the past from the Central Repository. A participant may choose not to share performance data with the repository, in which case a potential partner who has a preference for such data may reduce that participant's score in a trading rule from what it might otherwise have been. In this manner participants can trade in accordance with their secretly held preferences but others who choose not to show how they match up on one or more criterion can still participate but are penalized in the eyes of the particular other potential partner.

In one embodiment, the performance data may be provided as a general rating. For example, a participant's delivery performance data for all transactions conducted through the system of the present invention could be evaluated and scored into an overall rating. Alternatively, performance data may be provided on a more individualized basis by evaluating only the performance between two specific participants. For example, a retailer may be interested in how well a particular distributor has met that retailer's delivery deadlines. In this case, only the distributor's delivery performance in connection with that retailer is considered when rating the delivery performance of the distributor.

Although each node typically has its own individual trading rules stored locally, the Central repository may also store standard settings for certain rule parameters 240, subject to the qualification that a participant may choose not to share any information with the repository but still retain a position of good standing on the network. Typically, these standard rule parameter settings are intended to be used by a particular group. For example, a manufacturer may stipulate rule parameters that cause its own brands to be ranked more favorably than others in deciding which items to sell or which to buy. The manufacturer then might offer incentives to get its dealers to use its rule specifications. Buying groups or large wholesalers may have standard rule parameters for use by group members or associated retailers.

When a centrally maintained rule specification is updated, a node that uses the standard rule specification may have a setting that automatically accepts updates, or a node may get an update and then be able to decide whether to accept the change.

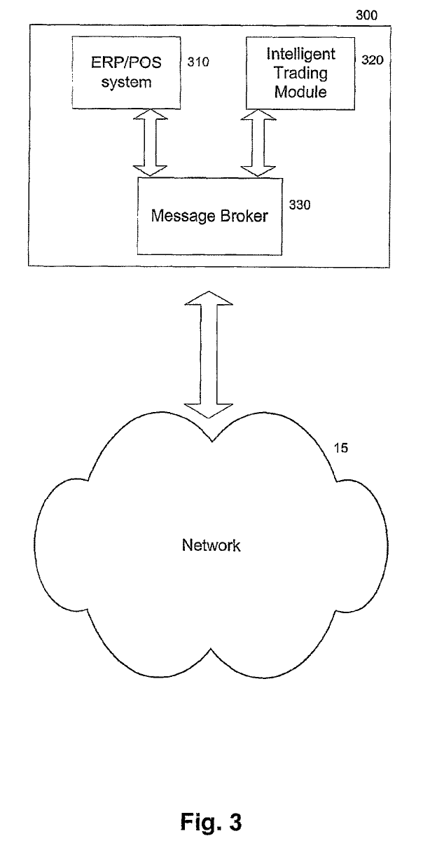

One architecture for a trading node 300 is shown in FIG. 3. As shown in this embodiment, a node may have three components: an ERP/POS system 310, an Intelligent Trading Module 320 and a Message Broker 330. The Intelligent Trading Module and the Message Broker are software components specific to the trading network of the present invention, while the ERPIPOS system is typically a legacy system at the node, and is integrated into the trading network of the present invention.

The ERPIPOS system 310 is an integrated enterprise system that provides ERP (Enterprise Resource Planning) and/or POS (Point of Sale) functionality to a business. The ERP/POS system 310 typically has accounting, inventory, pricing and warehouse management capabilities. In one embodiment, to integrate an existing ERP system with the present invention, the ERP system is extended to exchange messages with the Intelligent Trading Module. Typically, these messages include requests, for available quantities and prices of particular inventory items and responses to the requests, acceptance of orders, confirmations, and requests to initiate trading activity and acceptance of the results of those requests.

Intelligent Trading Module 320 is a software component that makes trading decisions for the node using the trading rules. For example, the Intelligent Trading Module may decide with which nodes it will trade, whether it will make an offer to sell in response to a request for purchase, how many items to buy or sell, and under what conditions items will be bought or sold. The Intelligent Trading Module may make these decisions automatically, or it may prioritize options for displaying to an end-user to make a final trading decision.

In one embodiment, the Intelligent Trading Module does not perform any processing or store any data that is a normal function of an ERP/POS system, such as processing or data related to product availability, pricing, tax and shipping charges. Rather, the Intelligent Trading Module determines pricing, inventory quantity-on-hand, tax and shipping cost information as needed by communicating with the ERP/POS system. Likewise, the Intelligent Trading Module may transmit Purchase Orders and other orders to the ERP/POS system. The Intelligent Trading Module receives requests from the ERP/POS system to search for goods on the trading network of the present invention, communicates the results of those searches back to the ERP/POS system, and receives ERP/POS requests to accept particular offers to sell.

Intelligent Trading Module 320 and ERP/POS system 310 may communicate with each other via messages that are routed through Message Broker 330. The message broker 330 may be a separate software component, or message broker functionality may be integrated into the Intelligent Trading Module and/or the ERP/POS system. Communication between the Intelligent Trading Module 320 and other nodes in the trading network is typically handled by the message broker. The Intelligent Trading Module 320 also typically communicates with the Central Repository through the message broker.

In one embodiment, Message Broker 320 is a separate software module that facilitates information traveling between two or more resources (e.g. different partners or software components within a single node). Use of the Message Broker 320 allows the communicating resources to operate independently and differently (e.g. under different operating systems). The message broker may transform data from one form to another between the resources. In one embodiment, commercially available message broker software may be used as the message broker component in the present invention. One example is Microsoft BizTalk Server. Alternatively, custom message broker software may be developed for use with the system of the present invention. The message broker component of the present invention is intended to cover any method of transmitting messages from one trading partner to another or between software modules within a single node.

Message Processing

Communication between nodes in the trading network of the present invention is accomplished by sending messages between nodes. These messages are preferably private, and may be encrypted. The messages may be encrypted through use of Public Key Infrastructure methods. In one embodiment, internode messages travel over the open Internet using standard http protocol. Alternatively, the messages may travel over a private network. Typically, a node receiving a message from another node is able to identify the sending node.

In one embodiment, communications are in the form of XML messages. XML (Extensible Markup Language) is a meta-language for defining structured information. It is used to define the structure and specify the content of messages sent between nodes and between modules within a node. Other formats are known to those skilled in the art may be used instead, and are intended to come within the scope of the present invention.

The XML messages may include many different types of objects. For example, a dealer object may correspond to a business entity on the trading network. A business with multiple selling or stocking locations may be represented by a single dealer object. Dealer attributes are typically stored in the Central Repository. These attributes may include a dealer ID and a dealer name.

Another example of a type of object that may be used in the messages is a part number description. Attributes may include manufacturer name and a unique part number. This object will also typically include different attributes for different types of commodities.

Other object types will be obvious to those skilled in the art and are intended to come within the scope of the present invention.

Many different types of messages may be transmitted between nodes in the trading network of the present invention. For example, a Purchase Request message may be sent by a prospective buyer to one or more potential sellers to request a specific item. In one embodiment, the purchase request merely asks if the seller is willing to sell items as specified. Alternatively, the purchase request may be a firm offer to buy.

The fields included in a purchase request of the present invention may include a reference number, sent time, buyer, seller, ship-to address, quantity, part number description, generic product description, required delivery date, and whether partial fulfillment of the order is acceptable, for example. Other fields that may be used in a purchase request will be obvious to one skilled in the art and are intended to come within the scope of the present invention.

Other types of internode messages may include offers to sell (unsolicited, or in response to a purchase request), offer acceptances (in response to an offer to sell or an offer to buy, typically representing a commitment to purchase according to the specification of that offer), acceptance responses (typically sent in response to an offer acceptance confirming or disconfirming the sender's commitment), purchase orders (typically an unsolicited commitment to purchase according to delivery terms and prices previously established), purchase order responses (confirming or disconfirming the purchase order), invoices (typically sent by a seller to a buyer subsequent to an acceptance confirmation or purchase order response; typically represents a request for payment), and advanced shipping notices (typically sent by a seller to a buyer subsequent to an acceptance confirmation or purchase order response giving notice that the order is being shipped).

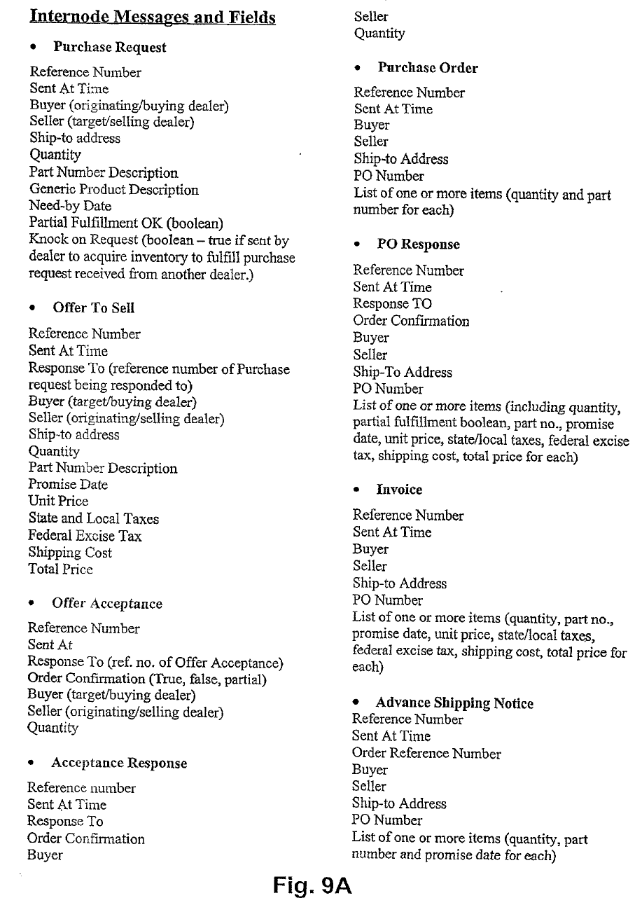

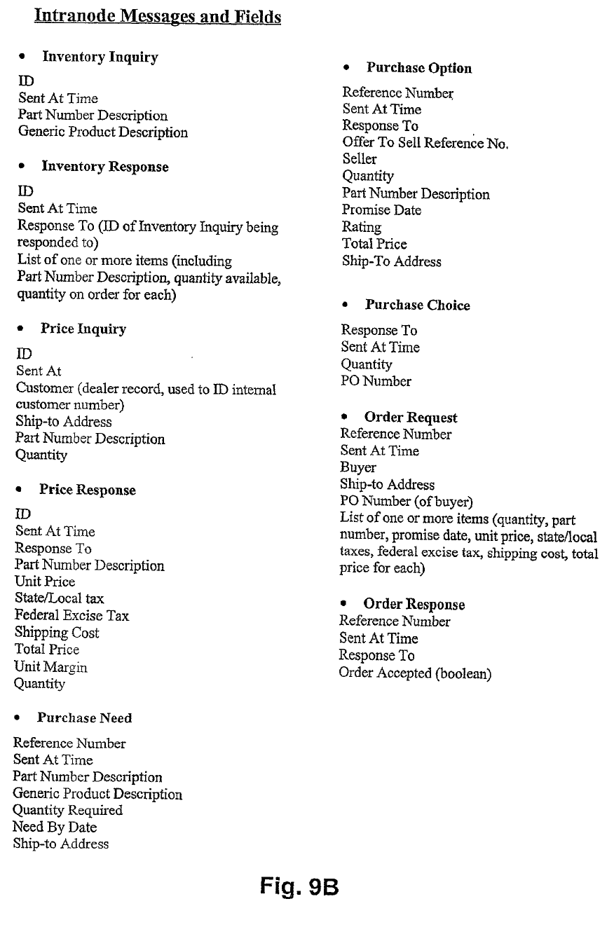

FIG. 9A illustrates several different types of internode messages that may be used by the trading network of the present invention, and fields that these messages may include. Other types of messages and fields will be known to those skilled in the art and are intended to come within the scope of the present invention.

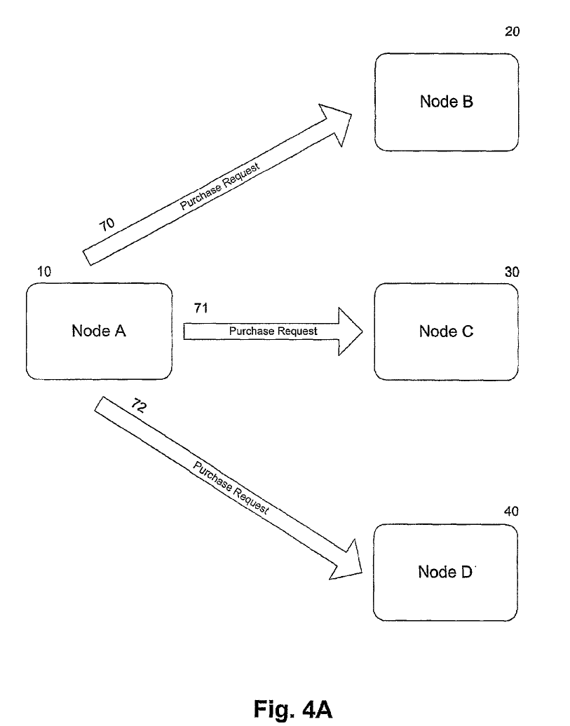

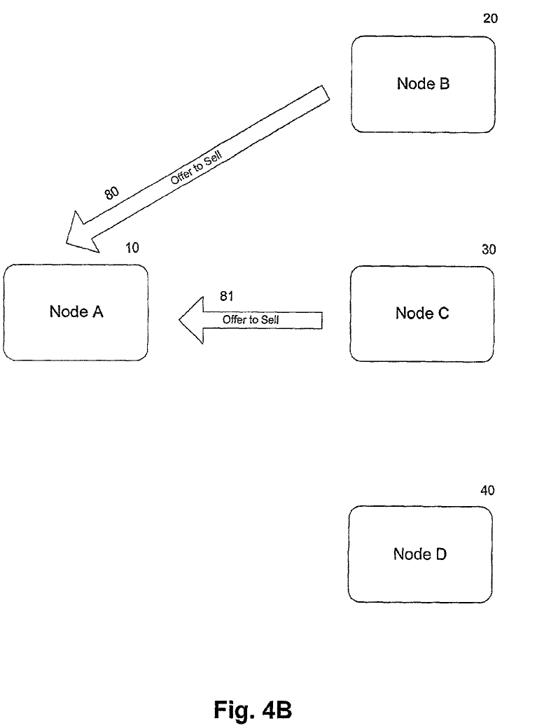

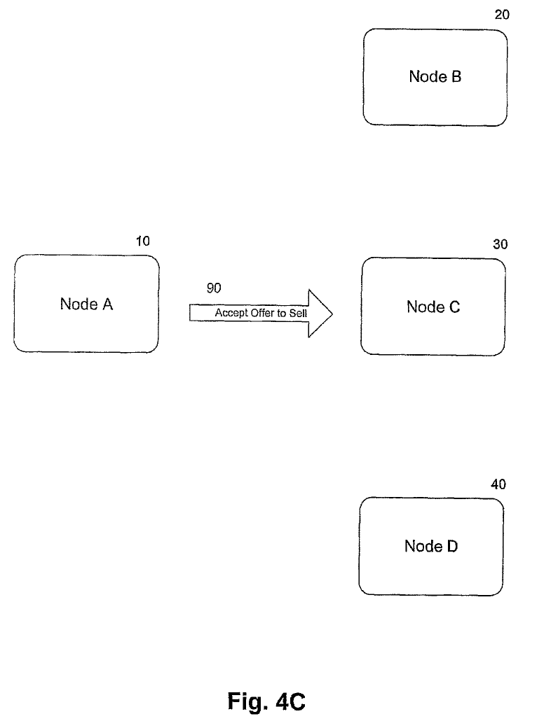

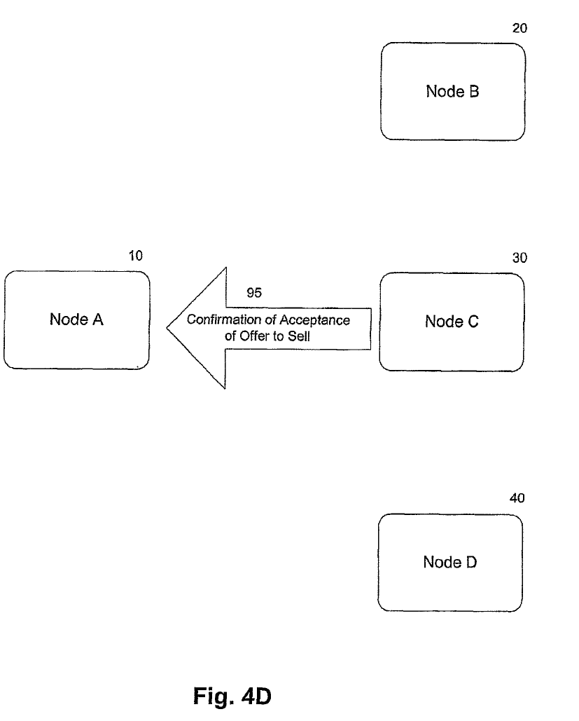

FIGS. 4A-4D illustrate some of the messages that may be sent between nodes in a typical purchase transaction scenario using the trading network of the present invention. This example illustrates the process for fulfilling a purchase request, however, as will be obvious to one skilled in the art, similar processes can be used for other types of transactions.

In this example, Node A may be a retailer desiring to purchase a specified set of goods, and Nodes B, C, D and E may be distributors. As shown in FIG. 4A, Node A may send a purchase request 70, 71, 72 to Nodes B, C and D inquiring if they are willing to sell a specified set of goods. As shown in FIG. 4B, Nodes B and C may respond to Node A with non-binding offers to sell 80, 81 that are responsive to the purchase requests 70, 71. An offer to sell typically includes the full price of the goods offered, including tax and shipping charges, and typically includes specific part numbers. As shown in FIG. 4C, after evaluating the offers to sell, Node A may respond to Node C with an acceptance 90 of the offer to sell 81 that commits Node A to buy according to the price specified in offer 81. Then, as shown in FIG. 4D, Node C may send a confirmation of an acceptance of the offer to sell 95 back to Node A. This confirmation commits Node C and indicates initiation of the process of fulfillment. Node C may also send an invoice and an advance shipment notice to Node A.

The present invention may also support intranode messaging, typically between a node's ERP system and the Intelligent Trading Module of the present invention. For example, the Intelligent Trading Module may send an inventory inquiry message to the BRP system. An inventory inquiry message allows the Intelligent Trading Module to determine inventory status of a particular inventory item or the status of all inventory items that meet a generic description. The inventory inquiry message may include identification, sent time, part number and generic product description on fields, for example. FIG. 9B illustrates some several types of intranode messages that may be used by the trading network of the present invention, and fields they may include. Other types of intranode messages and fields are possible, and are intended to come within the scope of the present invention.

In addition to internode and intranode messaging, the trading network of the present invention may support messages between nodes and the central repository. These messages may be used to maintain network information and allow new nodes to join the network, for example.

Node-repository messages may include message for a node update, node removal or a node list request. Other types of node-repository messages will be obvious to one skilled in the art and are intended to come within the scope of the present invention.

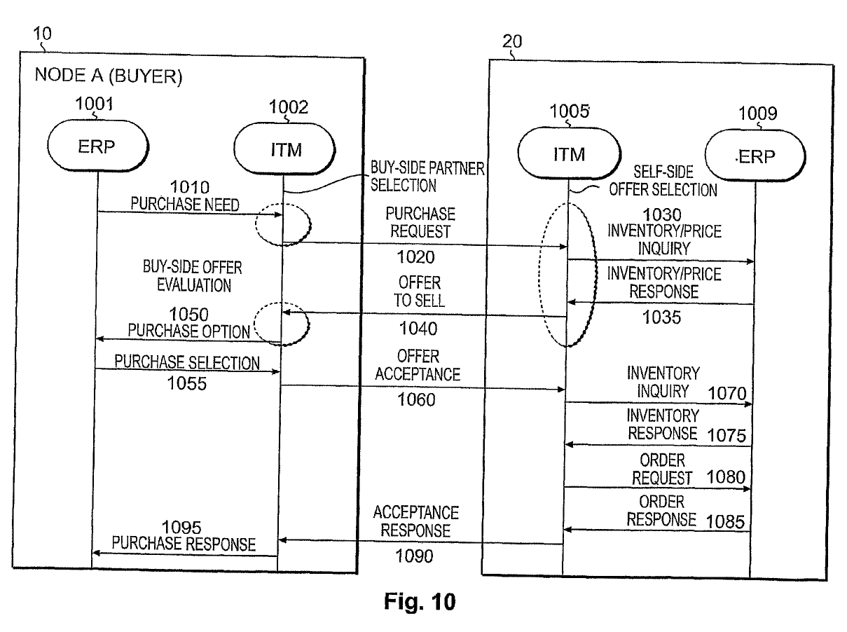

FIG. 10 illustrates an example transaction that illustrates use intranode messaging as well as internode messaging to process a transaction. In this example, the purchase request transaction is initiated by a user at Node A using Node A's ERP system. In an alternative embodiment, purchase requests may be automatically generated by the system according to a trading rule.

As shown in FIG. 10, before the Intelligent Trading Module 1002 on Node A sends a purchase request to participants in the trading network, a user at Node A may use the ERP system 1001 to first cause a purchase inquiry to be sent to the Intelligent Trading Module 1002. This is shown by purchase need 1010 in FIG. 10. The Intelligent Trading Module 1002 on Node A then uses the node's trading rules to determine to which network participants to send a purchase request, and sends a Purchase request to those nodes, as shown by Purchase request 1020 in FIG. 10.

Once a trading partner (Node B) receives purchase request 1020, its Intelligent Trading Module 1005 may send an Inventory/Price Inquiry message 1030 to its local ERP system 1009. This message is used to determine available inventory and current pricing of the specified products. The local ERP system 1009 may respond with an Inventory/Price Response message 1035 that specifies price and availability of relevant inventory items. By connecting the Intelligent Trading Module with the ERP system, current information regarding constantly changing inventory and pricing can be obtained.

Node B's Intelligent Trading Module 1005 determines which, if any, of the inventory items to offer in an Offer to Sell message 1040 back to Node A.

After Node A receives one or more Offers to Sell, its Intelligent Trading Module 1002 then evaluates the offers and may pass the offers on to Node A's ERP system 1001 in ranked order through a Purchase Options message 1050 for selection by the user who first initiated the trading sequence. The selection made by the user is then passed back to the Intelligent Trading Module through a Purchase Selection message 1055. In this example, the user is making the selection, however, as described earlier, selections may be made automatically by the system.

The Intelligent Trading Module 1002 then generates an Offer Acceptance message 1060 to the corresponding trading partner of the selected offer. In the example shown in FIG. 10, Node B made the Offer that was selected by the user.

Once Node B receives the Offer Acceptance message 1060, its Intelligent Trading Module may check to see if inventory is still available by sending an Inventory Inquiry message 1070 to its ERP 1009, and then receiving a corresponding Inventory Response 1075 from the ERP 1009. If inventory is still sufficient, the Intelligent Trading Module 1005 may generate an order by sending an Order Request 1080 to its ERP system 1009. The ERP system 1009 may then send back a Order Response message 1085, and the Intelligent Trading Module 1009 sends the Acceptance Response 1090 to Node A to confirm (or disconfirm) the order.

Once Node A receives the Acceptance Response, its Intelligent Trading Module may send a Purchase Response 1095 to is ERP 1001 confirming the purchase to the user who initiated the transaction. Trading Rules Every participant in the trading network of the present invention has an individual set of trading rules. These rules typically control trading decisions. There are generally two categories of trading rules per node—Buy-Side trading rules which control the purchasing behavior of a node, and Sell-Side trading rules that control the selling behavior of a node.

Buy-Side trading rules define the preferences of a node in a purchasing situation. Buy-Side rules may address preferences for buying a particular brand(s), buying from a particular dealer(s), buying from a particular class of dealers, buying from a geographically proximate dealer, price thresholds, delivery time thresholds, and whether an entire purchase should be made from a single dealer, for example.

One retailer in the trading network of the present invention may prefer to purchase goods from certain distributors. This retailer can establish a preferred trading partner rule that identifies the preferred distributors. As another example, a retailer may prefer to purchase from the geographically closest distributor or manufacturer, and may establish a trading rule such that distributors and manufacturers within a 10-mile radius of the retailer are considered “preferred.” Buy-Side trading rules may be further divided into control rules and evaluation rules. Control rules determine which nodes with which to trade, and evaluation rules determine which offers to display to the user, or alternatively, which offer to automatically accept. A rule may be both a control rule and an evaluation rule.

Sell-side trading rules define the preferences of a seller (typically a distributor) in a purchasing situation. Sell-side rules may address preferences for selling a particular brand(s), not selling to particular dealers, selling (or not selling) to a class of dealers, pricing (typically different for partner nodes than for competitor nodes), inventory minimum thresholds, and acceptable payment and credit records of trading partners, for example.

As an example, a manufacturer may prefer to sell to certain competitor distributors only under the condition of a significant product mark-up. The manufacturer may establish a trading rule that marks up the price to these distributors.

Similar types of rules may be established for other types of transactions. Although the description herein focuses on fulfilling purchase requests using the trading network of the present invention, the scope of the invention is intended to cover any type of transaction that may be conducted using the trading network of the present invention.

As discussed above, the decisions made by the trading network of the present invention may be based on various criteria, including partner preference, brand preference, geographical distance, etc. Furthermore, each participant may base decisions on different criteria. For example, participants may establish specific trading rules for specific trading partners. The rules are very flexible and customizable.

The trading rules are very powerful. By shaping who does business with whom, and on what terms, these rules can transform business relationships and alter market share. Formulating these rules provides a real competitive advantage to a dealer or distributor trying to buy or sell more intelligently or to a manufacturer or distributor who wishes to influence downstream business partners.

Typically, the trading network of the present invention ensures that these rules are not made known to other participants in the trading network of the present invention. By encapsulating rules, the rules are only accessible to the node for which they are defined. One node cannot view the rules of another node, in a preferred embodiment, unless the other node chooses to share the rules. Therefore, participants in the network expose only a minimum amount of information to other members of the network.

The trading rules may be set up when participants join the trading network of the present invention and the rules can be updated at any time. In addition, the trading network of the present invention may also “learn” certain rules for a node. That is, the trading network may use a history of transactions to determine preferences for a node. For example, if a node buys a certain amount from a particular supplier, the supplier may be categorized by the trading network as a “preferred trading partner” for that node.

One common use of both Buy-Side rules and Sell-Side rules is to identify preferred trading partners. There may be several different types of preferred trading partners. That is, a trading partner that is within a 10-mile radius may be “preferred”; a partner that primarily sells a particular brand may also be “preferred.” A trading rule may indicate that the geographical distance preference is more important than the brand preference, and therefore the trading network will rank a response from a geographically preferred partner higher than a response from a brand preferred partner, all other factors being equal. Additionally, a node may be categorized as “Non-preferred.” Such a categorization may, for example, allow a node to completely prohibit sales to any Non-preferred trading partners.

As mentioned above, another common trading rule is a proximity rule. In a proximity rule, a partner that is within a certain geographical distance may be preferred. In order for a node to know which Partners are within certain distance, the central repository preferably keeps a predefined table containing this information. When applying the proximity rule, the Intelligent Trading Module will then use the information stored at the central repository to determine proximity in real-time. Alternatively, the node may perform this calculation or store the information. In another alternative embodiment, nodes may be classified as “local dealers”, if they have locations within certain enumerated regions, such as a list of counties.

Another common trading rule concerns the price markup. It is common for one business to establish a set markup for sales to another business that is a certain percentage above a universally established price. For instance, when one node decides to sell to a particular retailer at a 20% markup, the markup is preferably applied to the node's price found in its ERP or POS system. (Price is typically the responsibility of a node's ERP or POS system).

Nodes in the trading network of the present invention typically have many trading rules. Applying each rule individually may result in different offers to sell (or buy) being preferred by a node. The trading network of the present invention may handle such conflicts in a number of different ways. For example, each rule may be given a priority, and conflicts are handled by yielding to the highest priority rule. Alternatively, each rule may be given a weight, and the responses to inquiries are weighed according to the sum of the weight of the rules. Priorities and/or weights may be set by users when rules are defined. Alternatively, priorities and weights may be learned by the trading network (i.e. the Intelligent Trading Module), through observation of the node's purchasing behavior.

In one embodiment, a scoring methodology may be used. For example, a node may prefer dealers that are close by, and prefer not to deal with trading partners that are more than 20 miles away at all. In this case, the node may establish a rule that gives trading partner that is within 1 mile is given a score of 100, a partner that is within 10 miles given a score of 75, a partner within 15 miles a score of 50, and partners that are between 15 and 20 miles from the requesting node are given a score of 0. In addition, if the node is more than 20 miles away, the node establishes a rule to not trade with the partner at all. In addition, the node prefers brand M-centric trading partners. If a trading partner is a brand M-centric trading partner, it gets a score of 100, if it is not, it gets a score of 0. Finally, the node prefers lower priced offers, and has established a rule that scores the absolute value of values on a scale of 0-100.

In addition to the scores, the node has established weights for each of the rules. The proximity of a trading partner is very important to this node; therefore this rule has a weight of 10. Pricing is less important, and is given a weight of 5. Finally, the brand-centric rule is given a weight of 2.

Continuing the above example, consider a node that has received 4 offers from 4 different nodes. Node 1 is located within 4 miles, and is a brand M-centric partner. However, the price it is offering is not exceptionally good, and the scoring algorithm gives it a score of 40 on the 0-100 scale. Node 2 is located 16 miles from the requesting node, is a Brand M-centric partner, and has the best price of all offers received, and is therefore given a price score of 100. Node 3 is located 22 miles from the requesting node, is not a brand M-centric partner, and is given a pricing score of 90. Node 4 is located 11 miles from the requesting node, is not a brand M-centric partner, and is given a price score of 60.

The weighted preference scores for these four nodes are shown below:

Node 1: (10×75)+(2×100)+(5×40)=1150

Node 2: (10×0)+(2×100)+(5×100)=700

Node 3: 0 (because the requesting node does not want to deal with nodes >20 miles away)

Node 4: (10×50)+(2×0)+(5×60)=800

In this example, even though Node 1 has the least preferred price of these 4 offers, it is the preferred offer by the requesting node. This example demonstrates how non-price factors can influence trading decisions made with the trading network of the present invention.

As will be obvious to one skilled in the art, there are many different ways of scoring, and many different algorithms to calculate a weighted sum of rules, as well as additional methods of resolving rule conflicts. It is intended that these come within the scope of the present invention.

The trading network of the present invention will now further be described through the use of several examples, which follow. Although these examples illustrate many of the different rules that may be used, it will be apparent to one skilled in the art that there many other rules and combinations of rules that may be applied, and these are intended to come within the scope of the present invention.

### EXAMPLE 1

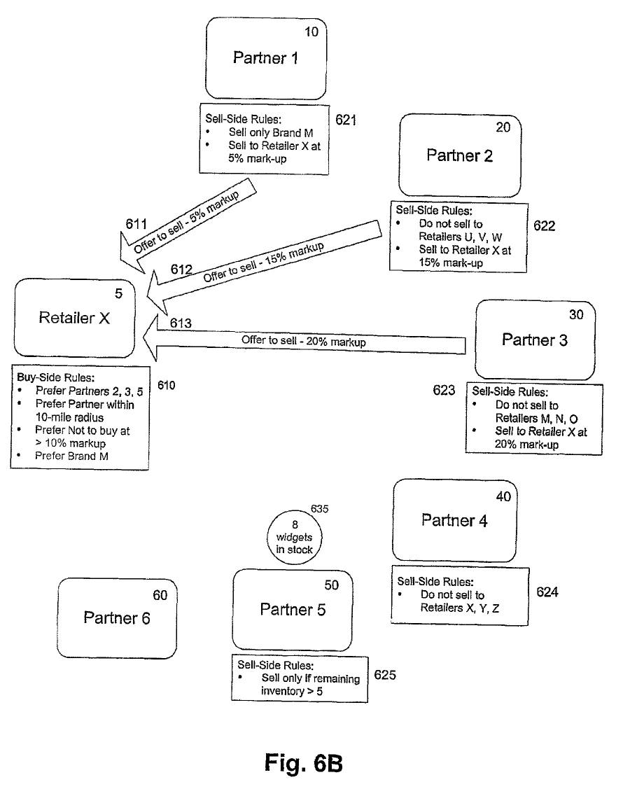

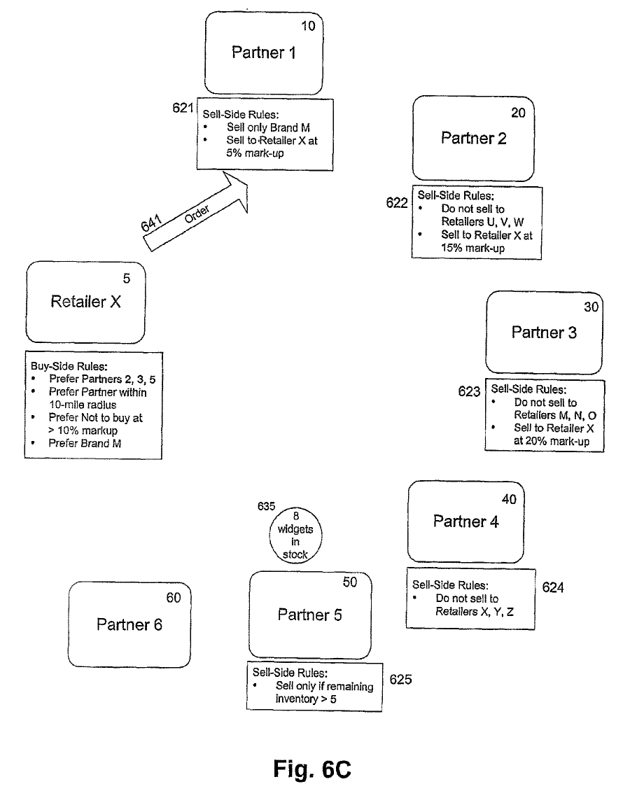

There are seven partners in the trading network example shown in FIG. 6A-Retailer X and Partners 1-6. As shown, Retailer X has established several widget Buy-Side rules 610, and each node has established their own widget Sell-Side rules 621, 622, 623, 624 and 625. It will be apparent to one skilled in the art that many additional rules could be established; the rules shown are intended to illustrate specific features of the trading network of the present invention.

The Buy-Side and Sell-side rules used in this example apply to widgets. The nodes may set up different rules for different commodities. They may even set up different rules for different brands of the same commodity.

In this example, a consumer goes to Retailer X seeking to purchase five widgets. Retailer X is connected to the trading network of the present invention.

Suppose Retailer X does not have any widgets in its own inventory. The customer representative at Retailer X may then initiate a “spot search” across the trading network of the present invention for the 5 widgets. In this example, suppose also that Partners 1 and 4 are within a 10-mile radius of Retailer X.

As shown, Partners 1-5 are contacted through the trading network of the present invention with a purchase request 601. As shown in Retailer X's Buy-Side rules 610, Partners 2, 3 and 5 are “preferred partners”, and Partners 1 and 4 fall within the 10-mile radius required by another of Retailer X's Buy-Side rules. As Partner 6 does not fall within either of these two rules, it is not a preferred trading partner and is therefore not contacted. The trading network of the present invention makes the decision as to which trading partners to contact automatically. The user at Retailer X using the trading network of the present invention does not have to make these decisions—he simply enters the inquiry into the system, the system does the rest.

As shown in FIG. 6B, Partner 4 does not respond to the request by Retailer X because it has established a Sell-Side rule 624 that restricts sales to Retailers X, Y and Z. Alternatively, Partner 4 could respond to the request, but decline to make an Offer to Sell in the response. Again, the response, or lack of response, is automatically generated by the trading network of the present invention. No human intervention or decision-making is required.

As shown by inventory 635, Partner 5 has only 8 widgets in stock. Therefore, as shown in FIG. 6B, Partner 5 does not respond (or responds in the negative) to Retailer X's request because it has a Sell-Side rule 625 that only allows sales if its widget inventory after the sale will be greater than 5. Since Partner 5 currently only has 8 widgets in its inventory 635, a sale of 5 widgets will deplete the inventory below its required minimum. Such inventory rules may be set up for each commodity that a node sells, or one rule may be set up to apply everything the nodes sells.

This determination is made automatically by the inventive system, and again no human intervention or decision-making is required. Although not shown, when making the determination, Partner 5's Intelligent Trading Module inquires of Partner 5's ERP/POS system as to the current inventory.

Partners 2 and 3 each have a variety of widgets in their inventory from different manufacturers and both respond to the request with offers to sell 612 and 613. Both Partners 2 and 3 have Sell-Side rules 622, 623 that specify markups on sales to Retailer X, and the responses 612, 613 from Partners 2 and 3 include these markups.

Partner 1 sells only Brand M widgets, and marks up the price to Retailer X 5%. It responds 611 to the request with an offer to sell with the 5% markup.

Again, these responses are automatically generated by the system of the present invention with no human intervention or calculations required.

Since Retailer X prefers Brand M widgets, and Partner 1's widgets are available for a 5% markup, which is less than Retailer X's Buy-Side rule 610 “prefer not to buy at >10% markup”, Partner 1's response 611 to Retailer X's purchase request 601 is determined to be the best matching response. Because of the large markup on the widgets from Partners 2 and 3, these responses are given lower precedence.

In this example, the responses from Partners 2 and 3 are given a lower precedence than Partner 1, even though Partners 2 and 3 are “preferred” nodes according to Retailer X's Buy-Side rules. The rules could alternatively be established to give the “preferred” status of a Partner greater weight in the comparison. If this were the case, the system may rank the responses differently.

The customer service representative at Retailer X tells the consumer that Brand M widgets are available, and the customer places an order for the widgets. As shown in FIG. 6C, Retailer X sends an order 641 to Partner 1 for the five Brand M widgets. The ordering process using the trading network of the present invention is automatic, and is discussed in more detail below.

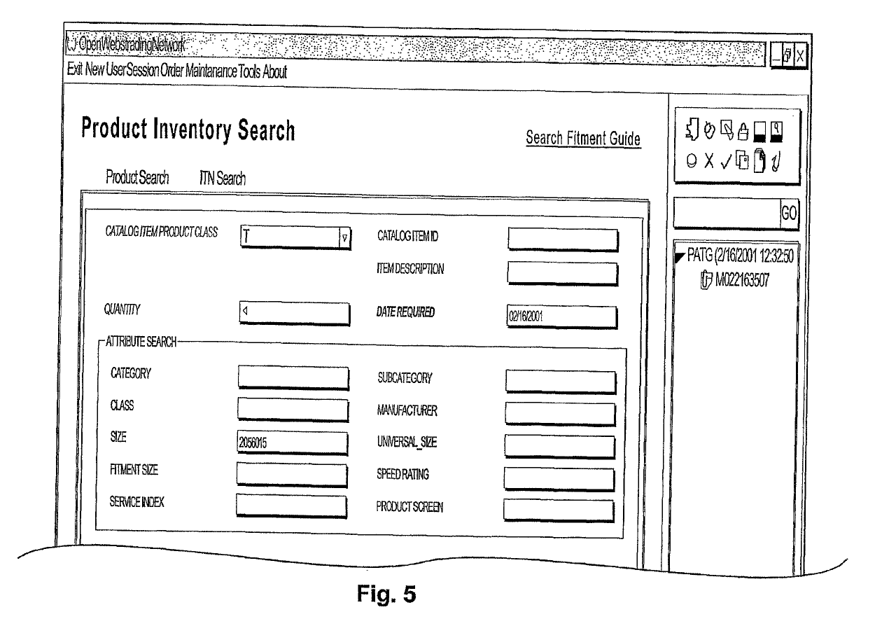

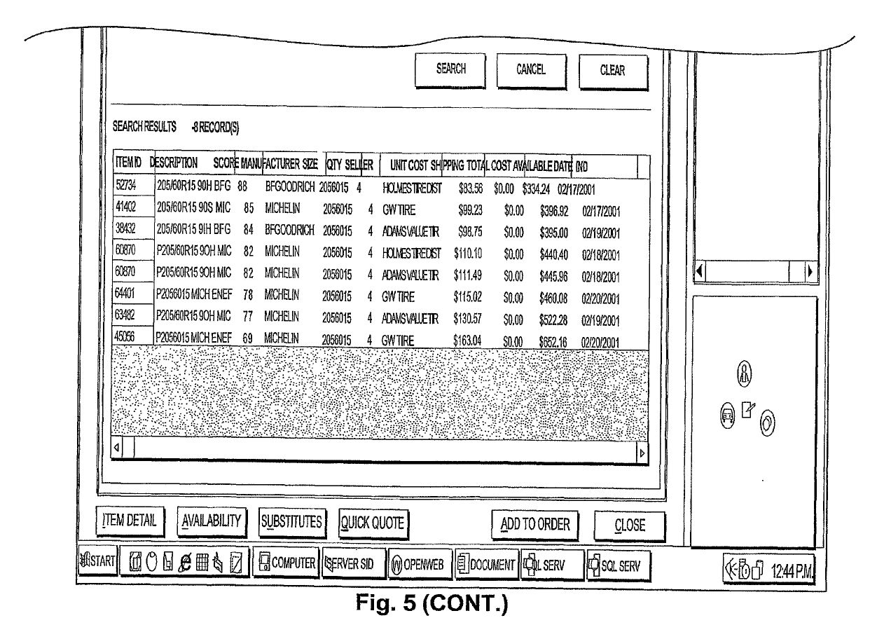

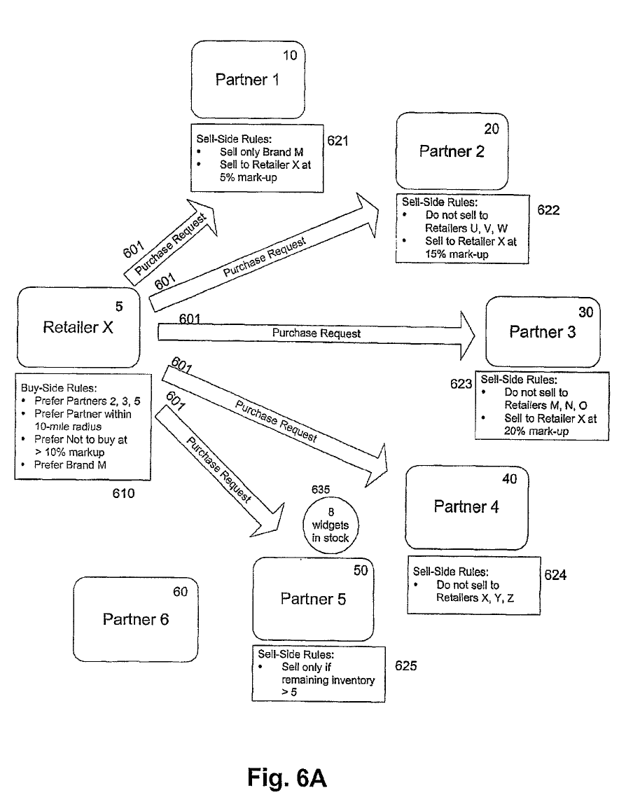

FIG. 5 is an example screenshot illustrating the offers to sell in an actual implementation of the inventive system. This particular implementation is for a tire retailing system. It shows eight offers of tires 520 from three different trading partners 530. The system has ranked the offers as shown in the score column 540. The offers were generated in response to an initial purchase request for tires of a certain size.

### EXAMPLE 2

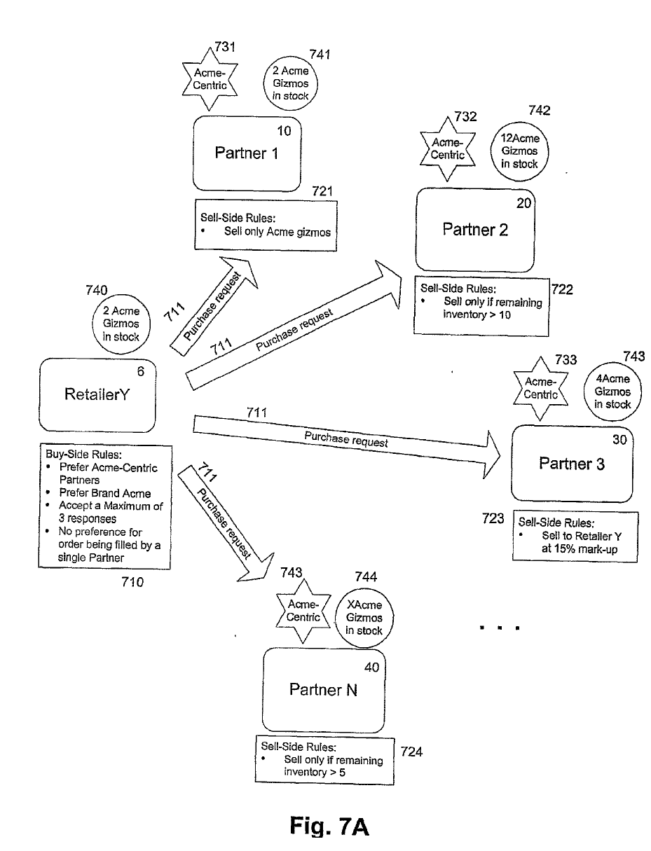

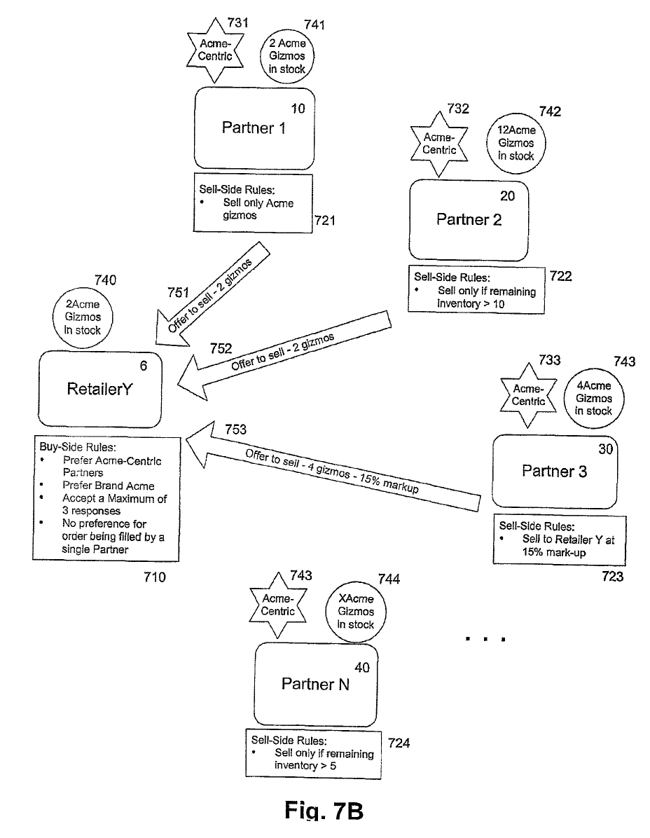

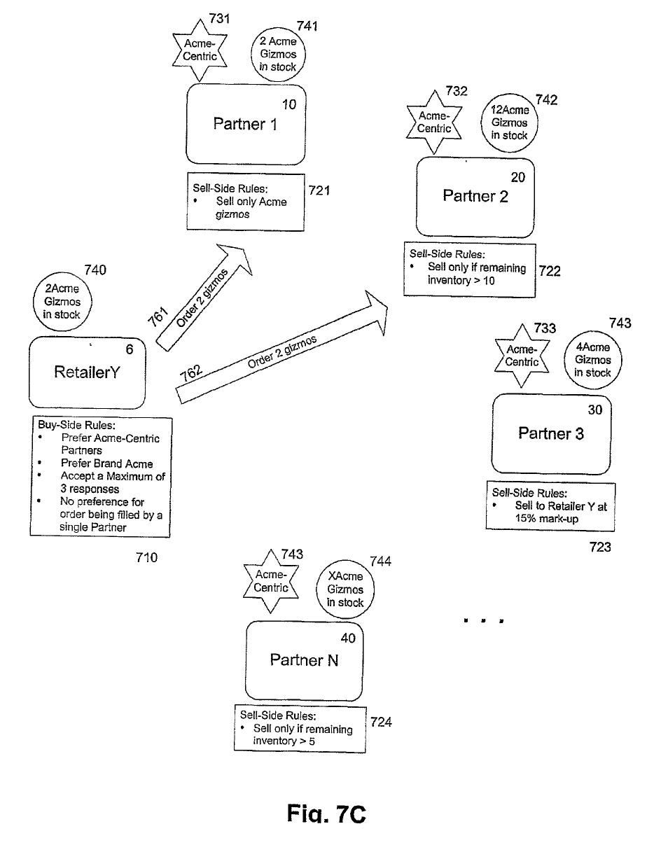

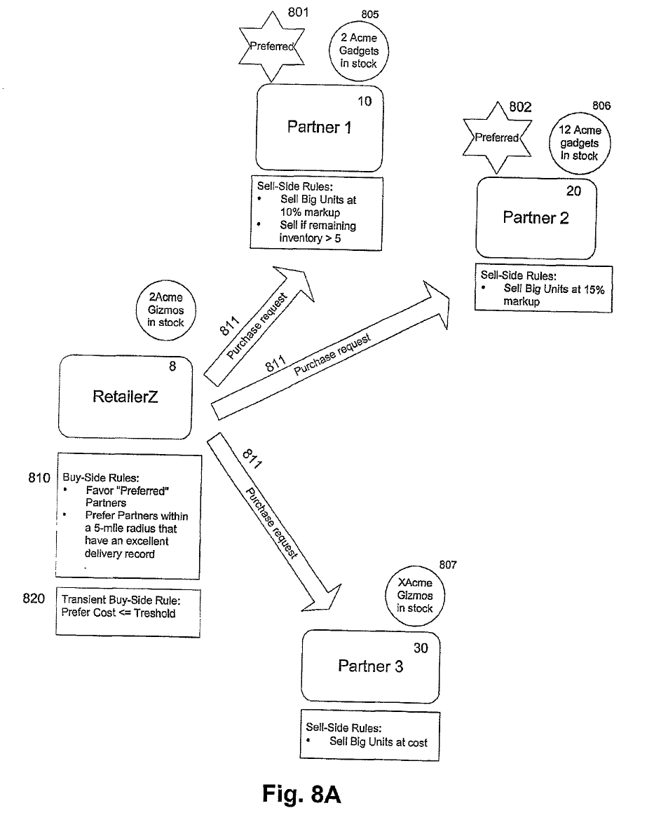

Consider a customer that requests 6 gizmos from Retailer Y. Since Retailer Y has only 2 gizmos in stock 740, a Retailer Y representative queries the trading network of the present invention for 4 additional gizmos. In this case, as shown in FIG. 7A, Retailer Y has a Buy-Side rule 710 that limits the number of responses that it will accept before displaying purchase options to the user. Partners 1-N are contacted by the trading network in the search for 4 gizmos.

Because Retailer Y has a Buy-Side rule 710 “Prefer Acme-Centric Partners”, the request for 4 gizmos 711 is sent to all N members of the trading network who are classified as Acme-Centric.

Partners may be classified as “Acme-centric” (or any other classification) upon registration with the network, or may be automatically classified by the system. For example, all dealers that sell more than a certain percentage of a certain brand of gizmos may be classified as a Brand-centric partner.

As shown in FIG. 7B, in this example, Partner 1 responds first with an offer to sell 2 gizmos 751. Since Partner 1 only has 2 gizmos in stock (inventory 741), it cannot offer to fulfill the entire request.

Partner 2 then responds with an offer to sell 2 gizmos 752. Since Partner 2 has the Sell-Side rule 722 that requires that remaining inventory after a sale be at least 10, it can only offer to sell 2 of its 12 gizmos.

Partner 3 then replies with an offer to sell 4 gizmos 753, and marks up the price of the gizmos 15% according to its Sell-Side rule 723.

A number of other partners, including Partner N, reply that they have sufficient stock on-hand to satisfy the request. However, as Retailer Y has a Buy-Side rule 710 limiting the number of responses to a request to three, and it has already received three responses, these later responses are queued. FIG. 7B illustrates the first three responses 751, 752, 753 received by Retailer Y in this example.

Because of the potentially large number of nodes that may be contacted by the trading network, the ability to limit the number of responses to a request before displaying the responses to a user is important. It would simply be too slow to wait for all responses before displaying a response to a user. Furthermore, users do not want to be overwhelmed with too many options. Such a rule balances speed of response with quality of solution.

Alternatively, responses could be limited by time instead of number of responses. For example, a rule could specify that the search can only proceed for 2 seconds. At the end of this period, the system makes decisions based on the responses that have been received. As another alternative, a disjunction between number of responses and time limit could be applied; e.g. stop processing responses after 2 seconds or 3 responses, whichever comes first.

If Retailer Y did not have the Buy-Side rule “No Preference for a Single Partner”, the system may have ignored the responses from Partners 1 and 2 since neither Partner 1 nor 2 can solely satisfy Retailer Y's request. Using this type of partial fulfillment rule, a requesting node may specify whether a request must be completely fulfilled or can be partially fulfilled by a trading partner. Further, the requesting node may specify a minimum threshold of items that must be offered for partial fulfillment. For example, a business is highly unlikely to want to fulfill a request for 100 items with suborders from 100 different vendors.

The current responses from Partners 1, 2 and 3 are displayed to the user at the node Retailer Y. In an alternative embodiment, the system could automatically choose the highest ranked response without displaying any of the responses to the user.

In this example, the user at Retailer Y informs the customer that the request can be filled by either 2 gizmos from each of Partners 1 and 2, or by the 4 gizmos from Partner 3, but at a markup. In this example, the customer chooses to order the gizmos from Partners 1 and 2. Retailer Y sends messages 761, 762 to Partners 1 and 2 to place the order, as shown in FIG. 7C.

### EXAMPLE 3

Transient rules can override predefined, persistent rules. Transient rules are those that are defined for and applied to only a single transaction, or set of transactions.

In this example, a customer requests a gadget at a cut-rate price from Retailer Z, This customer is a long-term, loyal customer, and has been patronizing Retailer Z for many years. Therefore, the staff as Retailer Z has a strong incentive to accommodate this customer.

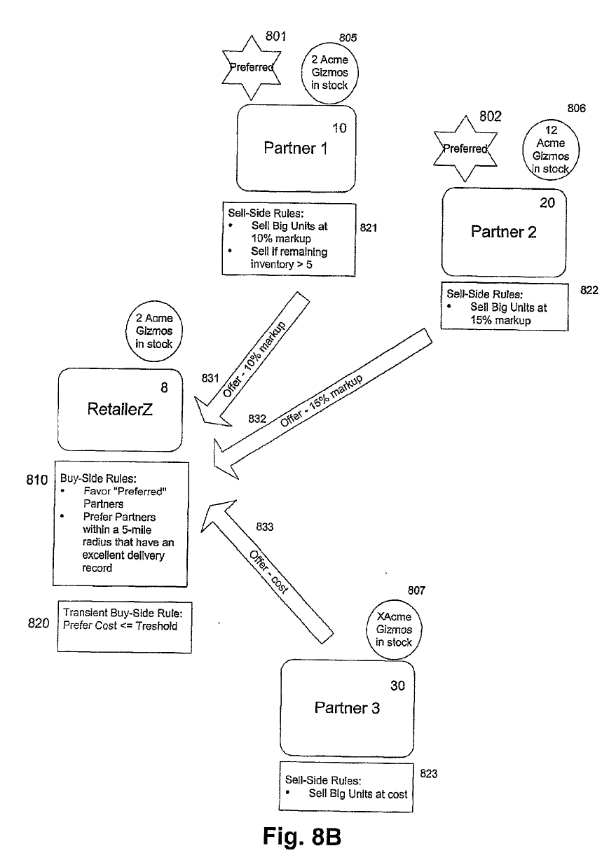

As shown in FIG. 8A, Partners 1 and 2 are typically favored by Retailer Z, and the system has automatically classified them as “referred” partners 801, 802 of Retailer Z. Partner 3 has not been classified as a “Preferred” partner, but is within a 5-mile radius of Retailer Z, and has good delivery record.

Under normal Retailer Z Buy-Side rules 810, purchasing requests are sent to Preferred partners, and partners within a 5-mile radius with good delivery records. In this example, the request 811 is sent to Partners 1, 2 and 3. As shown in FIG. 8B, Partner 1 has a satisfactory inventory 805 of gadgets, and responds with an offer to sell 831 at a 10% markup, per its Sell-Side rules 821. Partner 2 replies with an offer to sell 832 at a 15% markup, per its Sell-Side rules 822. Partner 3 replies with an offer to sell 833 at cost.

Because of the transient rule 820, Partner 3's offer is ranked above offers from both Partners 1 and 2, although Partners 1 and 2 are favored by Retailer Z. The customer is thus given the opportunity to order the gadget at cost.

Transient rules allow nodes to override predefined rules to handle special circumstances. In some markets, this may not be a desired feature, as it may affect profits. However, for many vertical markets, the emphasis may be on allowing the customer a full and open choice, including finding the lowest cost item, no matter who the supplier is.

Other types of rules not shown in these examples may also be used. For example, nodes may establish rules limiting trades to trading partners with good credit, payment or delivery records. Because the central repository stores this type of information, it can determine which are preferred partners. In addition, since the information is real-time, a node's payment record or delivery record can constantly change. The trading network of the present invention is able to provide nodes with accurate, up-to-date information.

In addition, this type of information could be individualized. For example, a node may establish a rule for classifying a trading partner as “Preferred” if that trading partner has a good delivery record with the node. Alternatively, the trading partner could be classified as “Preferred” if it has an overall good delivery record, regardless of its past history with the node.

Another rule that may be used is a margin preference. Margin refers to the difference between the amount a node pays for an item, and the amount for which it sells the item to another party. For example, Dealer A buys a tire for $30 and sells it for $45. The margin is 50%. As the seller, the higher the margin, the better. A seller may set up a Sell-side trading rule that only allows sells above a certain margin.

Classifications are usually not global, but rather node-specific. “Preferred” and “Nonpreferred” are typically relative to each particular node. Therefore, these classifications are typically stored local to each node. In addition, nodes may be classified in a number of different ways. For example, a node may be classified as both “Preferred” and “Brand X-centric.” The trading network of the present invention can be used in many situations, not just to send purchase requests for customers. For example, a retailer manager may need to restock the warehouse. He may use the inventive system to send multiple requests for those items that are not well stocked. In addition, inventory replenishment may be an automated process. Replenishment could be automatically triggered when inventory is low and rules may be established to control the final purchase decisions.

As another example, a node may use the trading network of the present invention to make an unsolicited sales offer. This may be useful, for example, in the case of inventory overstock. As with inventory replenishment, unsolicited sales offers may be an automated process.

The above, examples illustrate the value of peer-to-peer trading in a trading network, and the value of integrating the trading network with existing enterprise software.

Since the system supplies access to a large trading network the point-of-sale customer is provided with a rich set of choices. The end-customer is afforded the opportunity to make a choice based on a wide variety of characteristics, such as brand, price and location. If a product is not available at the physical point-of-sale, a business in the trading network of the present invention can still rapidly respond to an order by trading with another business in the trading network.

The trading network of the present invention allows for a “virtual warehouse” so that all members can avoid over-stocking. This leads to price reduction and increased profitability.

Each business in the trading network of the present invention conducts business according to its own priorities and chooses the degree to which its private information is shared with other members of the network.

Each participant in the trading network of the present invention perceives itself as being the center of the whole network and can access the disclosed resources of any or all of the other members of the virtual enterprise.

Although various embodiments are specifically illustrated and described herein, it will be appreciated that modifications and variations of the present invention are covered by the above teachings and within the purview of the appended claims without departing from the spirit and intended scope of the invention. For example, although the embodiments of the invention implement the functionality of the processes described herein in software, it can be appreciated that the functionality of these processes may be implemented in hardware, software, or a combination of hardware and software using well-known techniques.

1. A method of fulfilling a request on a trading network comprised of a plurality of trading partners, comprising the steps of:
(a) sending a request to at least one trading partner, whereby the request is sent only to trading partners chosen by a trading rule;
(b) receiving at least one response to the request from the at least one trading partner;
(c) ranking the at least one responses according to an evaluation rule; and
(d) accepting one of the at least one responses.

2. The method of claim 1, wherein the request is a purchase request and the response is an offer to sell.

3. The method of claim 1, wherein the request is a sale request and the response is an offer to buy.

4. The method of claim 1, wherein the at least one response is automatically generated by a trading partner.

5. The method of claim 1, wherein step (d) additionally comprises automatically accepting the highest ranked response.

6. The method of claim 1, wherein step (d) additionally comprises presenting the ranked responses to a user, and accepting the user's choice of responses.

7. The method of claim 1, wherein the trading rule takes into account whether the partner is a preferred trading partner.

8. The method of claim 7, wherein the determination of whether a trading partner is a preferred trading partner is made by using a list of predetermined trading partners.

9. The method of claim 1, wherein the trading rule is based on a minimum preferred partner score.

10. The method of claim 1, wherein the trading rule takes into account whether the partner primarily sells a certain brand of products.

11. The method of claim 1, wherein the trading rule takes into account whether the partner is located within a certain geographical area.

12. The method of claim 11, wherein the geographical area is defined by a list of regions.

13. The method of claim 12, wherein the list of regions is a list of counties.

14. The method of claim 11, wherein the geographical area is defined by a point and radius around the point.

15. The method of claim 1, wherein the trading rule takes into account whether the partner has an acceptable delivery record.

16. The method of claim 1, wherein the evaluation rule is based on price.

17. The method of claim 1, wherein the evaluation rule is based on promised delivery date.

18. The method of claim 1, wherein the evaluation rule is based on acceptable delivery record.

19. The method of claim 1, wherein the evaluation rule is based on brand.

20. The method of clam 1, wherein the evaluation rule is comprised of at least two criteria, and step (c) comprises using a weighted sum of the at least two criteria to rank the offers.

21. The method of claim 1, wherein the trading rule is based on at least two partner criteria, and step (a) comprises sending a request to at least one trading partner, whereby the request is only sent to trading partners that meet the rule based on all partner criteria.

22. The method of claim 1, wherein the trading rule is comprise of at least two partner criteria, and step (a) comprises sending a request to at least one trading partner, whereby the request is sent to trading partners that meet the rule based on any of the at least two partner criteria.

23. The method of claim 1, wherein step (c) comprises ranking the at least one responses according to a first evaluation rule, and if no single response is ranked highest, ranking the at least one responses again by a second evaluation rule.

24. The method of claim 23, additionally comprising ranking the at least one responses again by a third evaluation rule.

25. The method of claim 1, additionally comprising the step of:
(e) receiving a confirmation of the accepted response.

26. A method for a node in a trading network to respond to a request for a specified quantity of specified goods, comprising the steps of:
(a) receiving a request;
(b) determining whether to respond to the request according to a trading rule;
(c) generating a response according to said determination, wherein said response includes at least one node preference; and
(d) responding to the request with the response generated in step (c).

27. The method of claim 26, wherein said request is a purchase request, and said response is an offer to sell.

28. The method of claim 26, wherein said request is a sale request, and said response is an offer to buy.

29. The method of claim 26, wherein the trading rule is based on having a specified number of the specified goods remaining in inventory if the request is fulfilled.

30. The method of claim 26, wherein the trading rule is based on the node making the request being a preferred trading partner.

31. The method of claim 26, wherein the trading rule is based on the node making the request having an acceptable credit record.

32. The method of claim 26, wherein the trading rule is based on the node making the request having an acceptable payment history with the node responding to the request.

33. The method of claim 26, wherein the at least one preference includes determining a markup specific to the node making the request.

34. The method of claim 26, wherein the at least one preference includes selling an identified brand.

35. A method for a requesting node to determine which of a plurality of offers to accept, comprising the steps of:
(a) receiving a plurality of offers;
(b) ranking said offers using an evaluation rule; and
(c) determining whether to accept an offer.

36. The method of claim 35, additionally comprising accepting an offer sending an acceptance message to the trading partner that sent the accepted offer.

37. The method of claim 35, wherein the offers are offers to sell.

38. The method of claim 35, wherein the offers are offers to buy.

39. The method of claim 35, wherein said evaluation rule includes ranking an offer with an identified brand higher than offers with any other brand.

40. The method of claim 35, wherein said evaluation rule includes ranking the offer with the lowest price the highest.

41. The method of claim 35, wherein said evaluation rule includes setting a maximum number of offers to evaluate, and step (b) comprises ranking offers until the maximum number of offers has been received.

42. The method of claim 35, wherein said evaluation rule includes ranking only offers that complete an entire request.

43. The method of claim 35, wherein step (c) comprises determining the highest ranked offer and automatically accepting the highest ranked offer.

44. The method of claim 35, wherein step (c) comprises displaying the ranked offers to a user, and if the user selects an offer, accepting the offer the user selected.

45. The method of claim 35, wherein the ranking in step (c) is determined by using a weighted sum of criteria used by the evaluation rule.

46. A trading network comprising a plurality of nodes,
wherein at least one node is a different type of entity than at least one other node;
wherein any node participating in the trading network can trade with any other node in the trading network;
wherein each node has a set of private, individual trading rules that govern that node's trading behavior; and
wherein a first node may send a trading request to at least one second node according to the first node's trading rules, and the at least one second node determines whether and how to respond to the trading request according to the at least one second node's trading rules.

47. The trading network of claim 46, wherein the types of entities include retailers, distributors and manufacturers.

48. The trading network of claim 46, wherein the trading network is integrated with an internal order processing system at each node.

49. The trading network of claim 48, wherein the internal order processing system is an ERP system.

50. The trading network of claim 46, wherein the trading request is a message sent from the first node to the second node.

51. The trading network of claim 50, wherein the trading request is a message sent from the first node to the second node over the Internet.

52. The trading network of claim 50, wherein the message is in XML format.

53. The trading network of claim 50, wherein the message is encrypted.

54. The trading network of claim 53, wherein the encryption is done using public key cryptography.

55. The trading network of claim 55, wherein X.509 digital signatures are used to verify the sending node's identity.

56. The trading network of claim 46, additionally comprising a central repository.

57. The trading network of claim 56, wherein the plurality of nodes communicate with the central repository through messages.

58. The trading network of claim 57, wherein a message between a node and the central repository is in XML format.

59. The trading network of claim 56, wherein the central repository stores information about each of the plurality of nodes in the trading network.

60. The trading network of claim 56, wherein the central repository gathers and stores trading performance information.

61. The trading network of claim 60, wherein the stored performance information is used to determine a participating node's scored performance.

62. The trading network of claim 56, wherein the central repository stores global rule parameters that a node may use as its own individual rule parameters.

63. A method for a node in a trading network to make a request to at least one other node on the trading network, comprising the steps of:
(a) calculating a score for each of a plurality of trading nodes on the trading network using at least one criterion established by the requesting node;
(b) for each of the plurality of trading nodes, determining if the calculated score meets a minimum threshold; and
(c) sending a request from a requesting node to any trading nodes that have a minimum score;
wherein the trading network makes the determination in step (b) and automatically sends the requests to the trading nodes with a minimum score.

64. The method of claim 63, wherein the calculation in step (a) is made by calculating a weighted average.

65. The method of claim 64, wherein the weighted average is calculated using a score for each of the at least one criteria, and a weight for each of the at least one criteria.

66. The method of claim 63, wherein if no calculated scores meet the minimum threshold, the minimum threshold is lowered, and the scores are recalculated.

67. A method for a requesting node to rank a plurality of responses to a request sent by the requesting node on a trading network, comprising the steps of:
(a) receiving a plurality of responses;
(b) calculating a score for each of the plurality of responses using at least one criterion established by the requesting node; and
(c) ranking the responses according to the calculated score;
wherein the trading network makes the calculation in step (b) and automatically accepts the highest ranked response.
